(19) United States
(12) Patent Application Publication
(10) Pub. No.: US 2024/0149202 A1
(43) Pub. Date: May 9, 2024

(54) FILTER UNIT WITH A CONICAL PARTICLE FILTER AND PROCESS OF MANUFACTURING SUCH FILTER UNIT

(71) Applicant: Dräger Safety AG & Co. KGaA, Lübeck (DE)

(72) Inventors: Stephan HAKE, Lübeck (DE); Tim ERHARDT, Lübeck (DE)

(21) Appl. No.: 18/501,117

(22) Filed: Nov. 3, 2023

(30) Foreign Application Priority Data
Nov. 8, 2022 (DE) 10 2022 129 441.2

(51) Int. Cl. B01D 46/52

(52) U.S. Cl. CPC B01D 46/521; B01D 2201/34

(57) ABSTRACT

A filter unit (100) is configured to filter out particles from a gas mixture flowing through filter unit (100). A process of manufacturing the filter unit (100) is also provided. A particle filter (1) is arranged in a housing (2, 4). The particle filter (1) has a larger end face (Sf.e), a smaller end face (Sf.a) and a lateral surface (M) between the two end faces (Sf.e, Sf.a). A circumferential gap (Sp) is formed between the lateral surface (M) and the housing (2, 4), which tapers towards the larger end face (Sf.e). To produce the filter unit (100), the particle filter (1) is inserted into a housing part (2), and a sealing compound is filled into the tapering gap (Sp). The sealing compound hardens and forms a sealing element (9).

### CROSS REFERENCE TO RELATED APPLICATIONS

This application claims the benefit of priority under 35 U.S.C. § 119 of German Application 10 2022 129 441.2, filed Nov. 8, 2022, the entire contents of which are incorporated herein by reference.

### TECHNICAL FIELD

The present invention pertains to a filter unit comprising a conical particle filter and a housing, and to a process of manufacturing such a filter unit. The particle filter is located in the housing and is capable of filtering out particles from a gas mixture flowing through the filter unit.

### SUMMARY

It is an object of the invention to provide a filter unit with a particle filter (particulate filter) and a housing, whereby the filter unit can be manufactured more easily than known filter units without significantly reducing the reliability of the filter unit. Furthermore, the invention is based on the object of providing a process for manufacturing such a filter unit.

The object is attained by a filter unit having filter unit features according to the invention and by a process having process features according to the invention. Advantageous embodiments of the filter unit according to the invention are, as far as useful, also advantageous embodiments of the process according to the invention and vice versa.

The filter unit according to the invention is capable of filtering out particles and optionally other substances from a gas mixture while this gas mixture flows through the filter unit. The particles are, in particular, airborne particles, dust particles, liquid droplets, or particles produced by abrasion. The further substances are, for example, microbes, bacteria, and viruses in the gas mixture flowing through the filter unit.

The filter unit has an inflow side (inlet side) and an outflow side (outlet side), and the gas mixture flows through the filter unit in a flow direction from the inflow side to the outflow side. The term “flow direction” describes in an idealized manner the direction in which a gas mixture flows through the particle filter during productive use (operation) of the filter unit. As a rule, this flow direction is parallel to a center axis of the filter unit.

The filter unit comprises a particle filter, a housing, and a sealing element (gasket element). The housing surrounds the particle filter, preferably completely, i.e., from all sides. Ideally, the housing is configured to be fluid-tight, except for an opening on the inflow side and an opening on the outflow side. Preferably, the housing is rigid, and the sealing element is deformable and thus capable of absorbing kinetic energy and pressure to a certain extent. The kinetic energy may result from an impact or other external influence on the filter unit. The pressure may result, for example, from the housing contracting and expanding due to a varying ambient temperature. The particle filter and the sealing element are located inside the housing. In addition, the sealing element helps to prevent or at least reduce a generally undesirable movement of the particle filter relative to the housing.

The particle filter is capable of at least partially filtering out particles and optionally the other substances mentioned above from a gas mixture flowing through the housing. The particle filter has an inflow-side end face, an outflow-side end face, and a lateral surface (shell surface) between the two end faces (front faces). The two end faces and the lateral surface surround the interior of the particle filter. The inflow-side end face faces toward the inflow side of the filter unit, and the outflow-side end face faces toward the outflow side. The gas mixture flows through the particle filter from the inflow-side end face to the outflow-side end face.

As a rule, the particle filter has a central axis. This central axis is ideally parallel to the flow direction of the particle filter and ideally coincides with the central axis of the filter unit. The two end faces are each perpendicular or oblique to the particle filter center axis. Usually, the two end faces are parallel to each other, but this is not mandatory. The lateral surface surrounds the center axis of the particle filter.

According to the invention, one end face of the particle filter is smaller than the other end face. Accordingly, the terms “smaller end face” and “larger end face” are used. The particle filter thus has a conical (tapering) shape. More specifically, if the smaller face surface is projected onto the larger face surface in a direction parallel or perpendicular to the flow direction, the projection of the smaller face surface is fully contained in the larger face surface. Preferably, the larger end face protrudes on all sides the projection of the smaller end face. The smaller end face can be the inflow-side end face or the outflow-side end face.

A circumferential gap is formed between the lateral surface of the particle filter and the housing. This circumferential gap tapers in a direction from the smaller end face to the larger end face, i.e., it becomes narrower in this direction. More precisely, in a plane perpendicular to the flow direction, the maximum width of the gap decreases in the direction from the smaller end face to the larger end face. This direction may be parallel or antiparallel to the flow direction. The sealing element is arranged completely or at least partially in this tapering gap and forms a closed circumferential curve.

Ideally, the sealing element completely seals the area between the lateral surface and the housing. In this way, the sealing element prevents a gas mixture flowing in the flow direction through the filter unit and therefore through the housing from flowing between the housing and the particle filter, thereby bypassing the particle filter. This feature forces the gas mixture flowing through to follow a path through the particle filter, which effect is necessary to filter out the particulates and optional other substances.

According to the invention, a circumferential gap is formed between the lateral surface of the particle filter and the housing. This gap tapers, i.e., becomes narrower, in the direction from the smaller end face to the larger end face of the particle filter. This feature facilitates the manufacture of the filter unit, and in particular as follows: A liquid or viscous sealant (sealing compound) can be dispensed into the tapering gap, from the wider side of the gap and thereby from the smaller end face of the particle filter. The sealant can be applied after the particle filter has been inserted into a part of the housing. The sealant flows into the gap and/or is pressed or otherwise conveyed into the gap. In many cases, the particle filter absorbs part of the sealant, and the absorbed part of the sealant bonds with the particle filter. It is possible to fill the sealant into the gap vertically or obliquely (at an angle) from above, with the gap tapering downward. Gravity helps to move the sealant into the gap. In many cases, gravity is sufficient to get the sealant into the gap.

Preferably, the particle filter has pleats. This configuration increases the effective surface area of the particle filter, compared to a flat particle filter. In some cases, it is possible for the sealing compound to flow into pleats of the particle filter and form part of the sealing element during manufacture of the filter unit. This provides an even better sealing effect.

In addition, when using the filter unit, a tapered gap has the following advantage over a gap that has a constant cross-sectional area along the flow direction: The gap must be sufficiently wide for the sealing element to hold the particle filter securely in the housing. In practice, the situation will often arise where the sealing element does not completely close the gap. If the gap had a constant cross-section, there would be a greater risk that a gas mixture flowing through it will bypass the particle filter and therefore a larger quantity of particles will not be filtered out of the gas mixture. Thanks to the invention, it is possible, on the one hand, for the sealing element to be wide enough at the level of the smaller end face and, on the other hand, for almost all particles to be filtered out at the latest at the level of the larger end face.

According to the invention, the tapered gap is formed primarily by the particle filter having a smaller end face and a larger end face. This feature makes it possible to implement the tapered gap in a housing of the filter unit, which has the usual shape of a housing. Typically, the housing comprises two pot-shaped housing parts that are fixedly connected to each other and together form the housing. Each housing part has a respective circular or elliptic or n-vertexed (n-gon) bottom and a circumferential wall, and is in particular in the form of a cylinder. Each housing part extends along a central axis, preferably the two central axes coinciding with each other. The cross-section of a housing part remains constant along the central axis. The invention can be implemented in combination with such a housing.

Note: The preferred feature that each housing part has the shape of a cylinder applies only ideally. In practice, the shape of the housing part usually deviates from an ideal cylindrical shape and in particular has a conicity of up to 3 degrees.

According to the invention, the particle filter has a smaller and a larger front surface. It is possible, but thanks to this feature not necessary, that the housing or a housing part of the filter unit tapers in the flow direction or against the flow direction. In many cases, a housing part with a constant cross-sectional area, in particular a cylindrical housing part, is easier to manufacture and/or to use than a differently shaped housing part. It is also possible for at least one housing part to have the shape of a truncated cone (frustum of cone), preferably with the larger end face of the truncated cone adjoining the smaller end face of the particle filter and/or the smaller end face of the housing part adjoining the larger end face of the particle filter and the gap therefore having a V-shaped cross section.

As a rule, an obtuse angle (blunt angle) is formed between the smaller end face and the lateral surface of the particle filter, i.e., an angle greater than 90 degrees, and an acute angle is formed between the larger end face and the lateral surface, i.e., an angle less than 90 degrees. The size of the obtuse angle and/or the size of the acute angle is another degree of freedom in the configuration of the filter unit according to the invention. How large the angle is can be determined depending on how thin or viscous a sealing compound is that is applied to the tapering gap when the filter unit is manufactured. The angle can also be determined depending on the distance between the two end faces of the particle filter and the shape of the housing.

Preferably, the obtuse angle just mentioned is between 100 degrees and 115 degrees, more preferably between 105 degrees and 108 degrees. Preferably, the acute angle just mentioned is between 65 degrees and 80 degrees, particularly preferably between 72 degrees and 75 degrees.

In one embodiment, the particle filter has a corrugated or pleated shape. This configuration increases the effective surface area of the particle filter without requiring significantly more space in the filter unit.

The particle filter is made of a filter material which is permeable to the gas mixture and filters out and absorbs particles from the gas mixture. The filter material from which the particle filter is made is preferably paper with an admixture of glass fibers, paper with interwoven carbon fibers or a plastic nonwoven or a membrane made of polytetrafluoroethylene (PTFE), in particular expanded polytetrafluoroethylene (ePTFE), or a combination of these materials. It is also possible that the particle filter is made of at least two layers, preferably each layer being made of at least one of the materials just mentioned, and preferably the two or at least two layers having different materials or combinations of materials. The embodiment with the corrugated or pleated shape often results in a particularly lightweight particle filter.

According to the invention, the particle filter has a smaller end face and a larger end face. In one embodiment, the particle filter has the idealized shape of a truncated cone. The two end faces each have the shape of an ellipse, in particular a circle. Preferably, these two ellipses/circles are perpendicular to the central axis of the particle filter. Preferably, the housing comprises a tubular part in the form of a cylinder or also a truncated cone which surrounds the particle filter.

In another embodiment, the particle filter has the idealized shape of a truncated pyramid. The two end faces each have the shape of an n-vertex (n-gon) with n>=3, in particular n=6. Preferably, each cross-sectional area through the particle filter that is perpendicular to the particle filter centerline also has the shape of an n-vertex. In one embodiment, the tubular housing part surrounding the particle filter in the form of a truncated pyramid ideally has the shape of a cylinder. In another embodiment, the tubular part has a cross-sectional area also in the shape of an n-vertex, preferably with the n-cornered cross-sectional area remaining the same along the longitudinal axis of the tubular part. It is also possible that a V-shaped gap is formed between the housing and the particle filter.

According to the invention, the particle filter is able to filter out particles from a gas mixture that flows through the filter unit and thus through the particle filter. In one embodiment, the filter unit additionally comprises a further filter element. Preferably, the further filter element is capable of absorbing at least one constituent from the gas mixture flowing through it, in particular a gaseous constituent, for example by absorption or adsorption. Preferably, the further filter element has the form of a rigid filter block, which particularly preferably comprises impregnated activated carbon. Such a configuration of the further filter element presents less flow resistance to the gas mixture flowing through it than another possible configuration of the further filter element. The further filter element is arranged—viewed in the flow direction—downstream of the particle filter. Because the further filter element is arranged downstream of the particle filter, fewer particles in the flowing gas mixture, ideally no particles at all, reach the further filter element. This effect is achieved because these particles have already been filtered out by the particle filter according to the invention. The risk of the further filter element becoming clogged by particles is reduced.

In one embodiment, the larger end face of the particle filter is the inflow-side end face. In this embodiment, the smaller, i.e., outflow-side, end face is preferably in contact with the additional filter element. This embodiment increases the reliability that no particles reach the further filter element or even the outflow side of the filter unit. In another embodiment, the larger end face is in contact with the further filter element and is the outflow-side end face.

Preferably, the sealing element completely closes the circumferential gap between the lateral surface of the particle filter and the housing. “Completely” means: except for generally unavoidable gaps and holes and other irregularities. In one embodiment, the sealing element is materially bonded (materially cohesive) to a circumferential outer region of the particle filter, this region being adjacent to the lateral surface of the particle filter, in particular being limited by the lateral surface. This embodiment increases the sealing effect of the sealing element and further reduces the risk of a portion of the gas mixture flowing through bypassing the particle filter. The sealing element can also be materially connected to an area of the optional further filter element.

Various processes are possible to produce a filter unit according to the invention. The process according to the invention to produce a filter unit according to the invention comprises the following steps:

A first pot-shaped housing part is provided. The first pot-shaped housing part includes a first opened end face and a first end face that is fully or at least partially closed. A gap occurs between these two first end faces, and a lateral surface extends between the two first end faces. Preferably, a first opening is recessed in the first partially closed end face through which opening a gas mixture can flow.

A second pot-shaped housing part is provided. The second pot-shaped housing part includes a second opened end face and a second at least partially closed end face. A gap occurs between these two second end faces, and a lateral surface extends between the two second end faces. Preferably, a second opening is recessed in the second closed end face through which opening a gas mixture can flow.

A particle filter is provided. The provided particle filter has a central axis and is capable of filtering out particles and optionally other substances from a gas mixture which flows through the particle filter parallel to the central axis. The particle filter has a smaller end face, a larger end face, and a lateral surface between the two end faces. If the smaller end face is projected onto the larger end face in a direction parallel to the flow direction, the projection of the smaller end face is completely contained in the larger end face. Preferably, the larger end face protrudes the projection of the smaller end face on all sides.

The particle filter is inserted into the first housing part. The larger end face of the particle filter faces the first closed end face of the first housing part, and the smaller end face of the particle filter faces the first opened end face. A circumferential gap is thus formed between the lateral surface of the particle filter and the first housing part. This circumferential gap tapers in a direction from the smaller end face toward the larger end face, that is, toward the closed end face of the first housing part.

A liquid or viscous sealing compound (sealant) is applied into or onto the circumferential gap, the compound being applied from the opened first end face. It is also possible that at least part of the sealing compound is applied to an area of the smaller end face adjacent to the peripheral edge of the end face, so that the sealing compound flows or diffuses into the gap and/or is absorbed by the particle filter.

The sealing compound in the gap hardens or becomes viscous and forms a circumferential sealing element. Ideally, the circumferential sealing element closes the gap completely against the first opened end face.

The second housing part is connected to the first housing part, with the first housing part holding the inserted particle filter. The two connected housing parts together form a housing. This housing surrounds the particle filter. Preferably, the housing completely surrounds the particle filter, i.e., from all sides, except for an inlet-side opening and an outlet-side opening and inevitable irregularities. Preferably, the two housing parts overlap after being joined.

In a preferred embodiment, gravity is utilized to cause or at least contribute to the sealant flowing into the tapering gap. According to this preferred embodiment, the first housing part is positioned so that the first opened end face faces vertically or obliquely upward and the first closed end face faces vertically or obliquely downward. The particle filter is inserted (introduced) vertically or obliquely from above into the first housing part positioned in this way. After insertion, the smaller end face of the particle filter is vertically or obliquely above the larger end face and points vertically or obliquely upwards. The liquid or viscous sealing compound is applied vertically or obliquely from above into or onto the circumferential gap. Preferably, the second housing part is then placed vertically or obliquely from above onto the first housing part and joined to the first housing part to form the housing. Preferably, the two housing parts overlap each other.

Preferably, the sealant hardens in the gap and then forms the sealing element. In one embodiment, the second housing part is placed on the first housing part before the sealing compound has fully cured (hardened). The second housing part can thereby deform the sealing compound and/or bring about a straight closure (surface) of the sealing element in the gap. This effect is particularly advantageous if the sealing compound expands during curing. If the two housing parts overlap, they are pressed against each other when the sealing compound expands. This increases the tightness of the housing.

As mentioned above, in one embodiment the filter unit comprises, in addition to the particle filter, a further filter element, preferably a rigid filter block, which particularly preferably comprises impregnated activated carbon. A preferred embodiment of a process to produce such a filter unit additionally comprises the following steps:
The further filter element is provided.
The provided further filter element is brought (inserted) through the opened second end face into the second housing part.
After the particle filter has been placed in the first housing part, the sealing compound has been placed in the circumferential gap and the further filter element has been placed in the second housing part, the two housing parts are joined together.
The housing thus formed encloses both the particle filter and the further filter element.

Preferably, the additional filter element is inserted vertically or at an angle from above into the second housing part. Gravity holds the additional filter element in the second housing part. This embodiment avoids the need to fix the further filter element in the second housing part until the two housing parts are joined together. After the two housing parts are joined together, the particle filter preferably holds the further filter element in place and prevents larger relative movements of the further filter element relative to the housing.

Both the particle filter and the further filter element have a central axis. As a rule, the extent (dimension) of the further filter element along this central axis is greater than the extent of the particle filter along the central axis. In one embodiment of the manufacturing process, the first housing part is a lid (cover) in which a flow-through opening is recessed, and the second housing part is a pot having a bottom, the bottom also having a flow-through opening recessed therein. The extension of the pot along its central axis is greater than the extension of the lid along its central axis. The particle filter is inserted into the lid, the further filter element into the pot. Preferably, the pot includes a coupling point to connect the filter unit to a support, such as a face mask. A gas mixture first flows through the particle filter in the lid and then through the further filter element in the pot.

In a modification, the further filter element is first inserted into the pot. Then the particle filter is inserted (introduced) into the pot. The smaller end face of the particle filter faces the opened end face of the pot. The further filter element is then located between the bottom of the pot and the particle filter. Afterwards, the lid is next connected to the pot. Again, a gas mixture flows first through the particle filter and then through the further filter element.

The filter unit according to the invention can be used, for example, as a component of a respiratory protection mask (respirator mask). A user wears this respiratory protection mask in front of his or her face and thus breathes in air. The respiratory protection mask causes particles and optionally further substances to be filtered out of the air.

The invention further relates to a respiratory protection mask. The respiratory protection mask comprises at least one filter unit according to the invention and a carrier for this filter unit. The carrier at least partially rests against the face of a user of the respirator. The filter unit is connected to the carrier or can be connected to the carrier, preferably detachably connected. It is possible that the respirator mask comprises two filter units arranged in parallel, wherein at least one filter unit is configured according to the invention.

In the following, the invention is described by means of embodiment examples. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cross-sectional view of a first embodiment of the filter unit according to the invention with a particle filter and a rigid filter block;

FIG. 2 is a cross-sectional view of a first embodiment of the filter unit according to the invention with a particle filter;

FIG. 3 is a perspective view of a particle filter in the form of a truncated cone;

FIG. 4 is a cross-sectional view of the particle filter of FIG. 3;

FIG. 5 is a schematic view related to the cross-sectional view of FIG. 4, showing the angles between the end faces and the lateral surface;

FIG. 6 is a perspective view of a particle filter in the form of a truncated pyramid with a hexagonal base;

FIG. 7 is view of a first intermediate result during manufacturing the filter unit according to the invention of FIG. 1: the pleated web is perforated, folded, and pushed together;

FIG. 8 is a perspective view showing a second intermediate result during manufacturing: the particle filter is inserted into the lid;

FIG. 9 is a schematic representation of a step in the manufacturing process: liquid sealing compound (liquid sealant) is filled into the lid from above.

FIG. 10 is a perspective view of the step shown in FIG. 9;

FIG. 11 is a perspective view of the step shown in FIG. 9; and

FIG. 12 is a perspective view showing a third intermediate result during manufacturing of the filter unit according to the invention: the liquid sealing compound has been introduced into the gap, has cured and, after curing, forms the sealing element.

### DESCRIPTION OF PREFERRED EMBODIMENTS

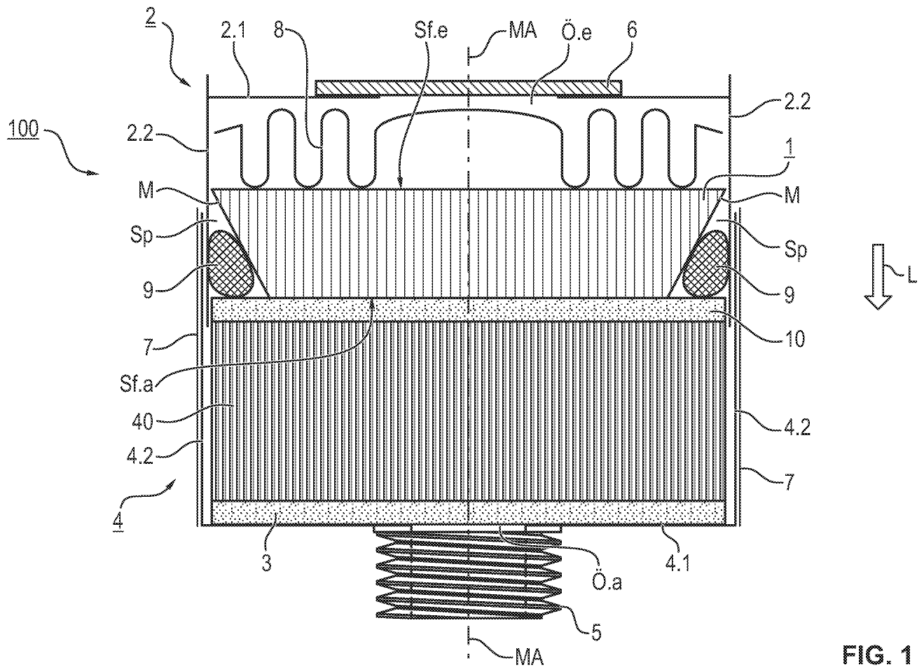

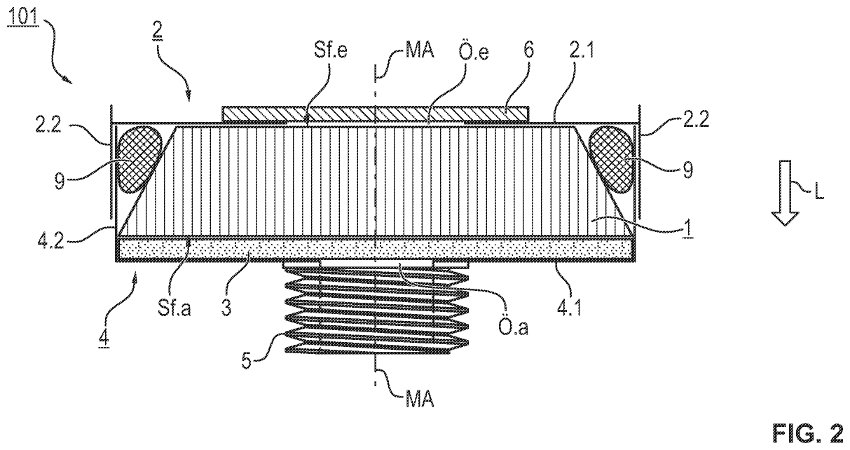

Referring to the drawings, FIG. 1 and FIG. 2 show in a cross-sectional view two embodiments of a filter unit 100, 101 according to the embodiment example. The illustration is not necessarily true to scale.

The filter unit 100, 101 is used to filter out particles and optionally harmful gases and/or other substances from a gas mixture flowing through the filter unit 100, 101. This gas mixture flows in a flow direction L from an inlet-side opening Ö.e through the filter unit 100, 101 to an outlet-side opening Ö.a. The flow direction L lies in the drawing planes of FIG. 1 and FIG. 2 and points from top to bottom. A central axis MA of the filter unit 100, 101 lies in the drawing planes of FIG. 1 and FIG. 2.

In the embodiment according to FIG. 1, a user uses the filter unit 100 to inhale filtered breathing air. The filter unit 100 comprises a coupling unit 5 for detachably connecting the filter unit 100 to a support (not shown) for the filter unit 100, for example to a face mask. In the embodiment shown, an external thread of the coupling unit 5 can be screwed into and unscrewed from a corresponding internal thread of the carrier. A filter unit 100 according to the invention can also be used in conjunction with a fluid conveying unit, which draws (sucks) in ambient air and conveys it through the filter unit 100.

The filter unit 100 of FIG. 1 further comprises the following components:
a particle filter 1 according to the invention with an inflow-side end face Sf.e, an outflow-side end face Sf.a, and a lateral surface M between the two end faces Sf.e, Sf.a,
a filter block 40 made of impregnated activated carbon, which is rigid in the embodiment example and acts as a further filter element,
a housing having a pot 4 (a pot shaped housing part) and a lid (cover) 2 (a pot shaped housing part), the lid 2 being connected to the pot 4,
a circumferential sealing element 9,
optionally a deformable inflow-side damping layer 10 and/or a deformable outflow-side damping layer 3,
optionally a corrugated further particle filter 8 between the inlet opening Ö.e and the inlet end face Sf.e, and
optionally a flame protection (flame retardant) 7 on the pot 4.

In one embodiment, the lid 2 overlaps with the pot 4 seen in a viewing direction that is perpendicular to the central axis MA. The pot 4 has a slightly larger dimension than the lid 2 in a plane that is perpendicular to the central axis MA. The lid 2 is connected to the pot 4 in such a way that, ideally, no particles can pass between the lid 2 and the pot 4 into the interior of the filter unit 100 and no particles can pass out of the interior in this way. In one embodiment, the lid 2 is connected to the pot 4 in a fluid-tight manner (fluid-tightly).

In the implementation shown in FIG. 1, the particle filter 1 has the shape of a truncated cone, with the inflow-side end face Sf.e being larger than the outflow-side end face Sf.a. The particle filter 1 has a central axis MA which extends parallel to the flow direction L. This central axis MA is ideally the axis of symmetry of the truncated cone and at the same time the axis of symmetry of the entire filter unit 100. The two circular end faces Sf.a, Sf.e are perpendicular to the central axis MA.

In the embodiment example, the rigid filter block 40 ideally has the shape of a cylinder and is arranged downstream of the particle filter 1, as seen in the flow direction L. The filter block 40 filters gaseous constituents out of the gas mixture flowing through it, from which gas mixture the particle filter 1 has already filtered out particles, in particular those constituents that are or can be hazardous (harmful) to a human being. In many cases, such a rigid filter block 40 made of activated carbon opposes a flowing gas mixture with less pneumatic resistance than another possible filter element.

The particle filter 1 and the optional further particle filter 8 filter out particles from a gas mixture flowing through the filter unit 100 before these particles reach the rigid filter block 40. This reduces the risk of the rigid filter block 40 becoming clogged with particles. In many cases, it is sufficient to use only particle filter 1 to filter out particles, but not the optional further particle filter 8.

In the implementation shown, the optional further particle filter 8 is integrated into the lid (cover) 2. It is also possible for the filter unit 100 to comprise a single particle filter 1 and for this particle filter 1 to be integrated into the lid 2, i.e., positioned in lieu and position of the particle filter 8.

The pot 4 comprises a base 4.1 and a tube 4.2. The lid 2 comprises an end face 2.1 and a tube 2.2. In the end face 2.1 of the lid 2, the inlet-side opening Ö.e is formed and defined thereby, and in the base 4.1 of the pot 4, the outlet-side opening Ö.a is formed and defined thereby. The inlet-side opening Ö.e is protected from the outside by an optional handle protection (grip protection) 6, which is applied to the outside of the end face 2.1. The optional flame protection 7 is applied to the lateral surface of the tube 4.2, for example glued on. In the example shown, the lid 2 has a slightly smaller diameter than the pot 4, so that the tube 4.2 of the pot 4 surrounds a segment of the tube 2.2 of the lid 2. This overlap further increases the stability of the filter unit 100.

In the example of FIG. 1, the pot 4 has the shape of a cylinder which is open towards the inflow side. The tube 4.2 can also have the shape of a truncated cone. A cross-sectional area through the pot 4, which is perpendicular to the drawing plane of FIG. 1 and perpendicular to the central axis MA, has the shape of a circle in the example shown, but may also have the shape of an n-gon (n-vertex shape) with n>=3, in particular a regular n-gon, where preferably n=6.

In the embodiment example, the particle filter 1 and the optional rigid filter block 40 are located inside the pot 4. The particle filter 1 can protrude upwards over the pot 4. Thanks to the shape of the particle filter 1, a gap Sp is formed between the tube 4.2 or 2.2 (depending on which is on the outside and which is on the inside) and the lateral surface M of the particle filter 1. In the example of FIG. 1, the gap tapers in the opposite direction to the flow direction L and away from the filter block 40 and towards the opening Ö.e on the inflow side. The circumferential sealing element 9 ideally has the shape of a circular ring (torus) and seals the gap Sp against the lid 2. This reduces, preferably completely eliminates, the risk that a gas mixture flowing through the interior of the housing 2, 4 bypasses the particle filter 1. In addition, the sealing element 9 reduces the risk of the particle filter 1 moving relative to the lid 2 or the pot 4.

In one embodiment, the sealing element 9 additionally dampens any possible movement of the rigid filter block 40 towards the lid 2. Thanks to the sealing element 9, the particle filter 1 can have a smaller maximum dimension perpendicular to the center axis MA than the pot 4, and the particle filter 1 does not need to be exactly centered to achieve its filtering action.

In the example shown, the optional inflow-side damping layer 10 is located between the particle filter 1 and the rigid filter block 40. The outflow-side face Sf.a is adjacent to the optional inflow-side damping layer 10 or directly to the filter block 40, and the inflow-side face Sf.e is adjacent to the optional additional particle filter 8 or directly to the inlet opening Ö.e in the lid (cover) 2. In many cases, no inlet damping layer 10 is required because thanks to the sealing element 9 the particle filter 1 is connected to the lid 2 or the pot 4 by a material bond. In many cases, a further particle filter 8 is also not required. The outflow-side end face of the rigid filter block 40 is adjacent to the optional outflow-side damping layer 3 or directly to the base 4.1. The two optional damping layers 3, 10 are able to absorb kinetic energy and reduce any possible movement of the rigid filter block 40 in the pot 4 parallel to the center axis MA.

FIG. 2 shows a filter unit 101 that is used exclusively for filtering particles and optionally microbes and liquid droplets from a gas mixture. Such a filter unit 101 is used, for example, to filter out particles from the air in a room or from the air flowing to a combustion engine. Identical reference signs have the same meaning as in FIG. 1. The filter unit 101 of FIG. 2 has no rigid filter block 40 and only an optional damping layer 3. The gap Sp tapers in the opposite direction to the flow direction L. In some applications, a coupling unit 5 is not required.

A modification of the filter unit 101 of FIG. 2 is also possible, in which the gap Sp does not taper in the flow direction L, but against (antiparallel to) the flow direction L. In this modification, as in FIG. 1, the inflow-side end face Sf.e is larger than the outflow-side end face Sf.a.

In the embodiment example, the particle filter 1 of FIG. 1 and FIG. 2 is made of a corrugated or pleated package (folded package). This pleated package is formed by pleating a flat filter material. The filter material is permeable to the gas mixture, but not to particles, and comprises, for example, paper with an admixture of glass fibers, paper with carbon fibers woven into it, or a plastic nonwoven, or a membrane made of polytetrafluoroethylene (PTFE), in particular expanded polytetrafluoroethylene (ePTFE), or even a combination of these materials.

According to the invention, the particle filter 1 has a larger end face and a smaller end face. In the example of FIG. 1, the outflow-side end face Sf.a is the smaller end face, and the inflow-side end face Sf.e is the larger end face. FIG. 2 shows a reverse embodiment, in which the outflow-side end face Sf.a is the larger end face and the inflow-side end face Sf.e is the smaller end face. The gap Sp thus tapers in the direction of the outflow-side opening Ö.a. In both examples shown, the lateral surface M extends between these two end faces Sf.a, Sf.e. In the embodiment example, the two end faces Sf.a, Sf.e are arranged parallel to each other and are perpendicular to the central axis MA. However, neither is mandatory: The two end faces Sf.a, Sf.e can also include an angle between them, and at least one end face Sf.a, Sf.e can be oblique on the center axis MA.

If one mentally projects the smaller end face Sf.a, Sf.e onto the larger end face Sf.e, Sf.a in a direction parallel to the center axis MA and parallel or antiparallel to the flow direction L, the projection of the smaller end face Sf.a, Sf.e lies completely inside the larger end face Sf.e, Sf.a. The larger end face Sf.e, Sf.a protrudes the projection of the smaller end face Sf.a, Sf.e at least in one segment, preferably to all sides. This feature allows the gap Sp to be formed between the inner wall of the cylindrical tube 4.2 and the lateral surface M of the particle filter 1. The gap Sp tapers in the flow direction L (FIG. 1) or in the direction opposite to the flow direction L (FIG. 2).

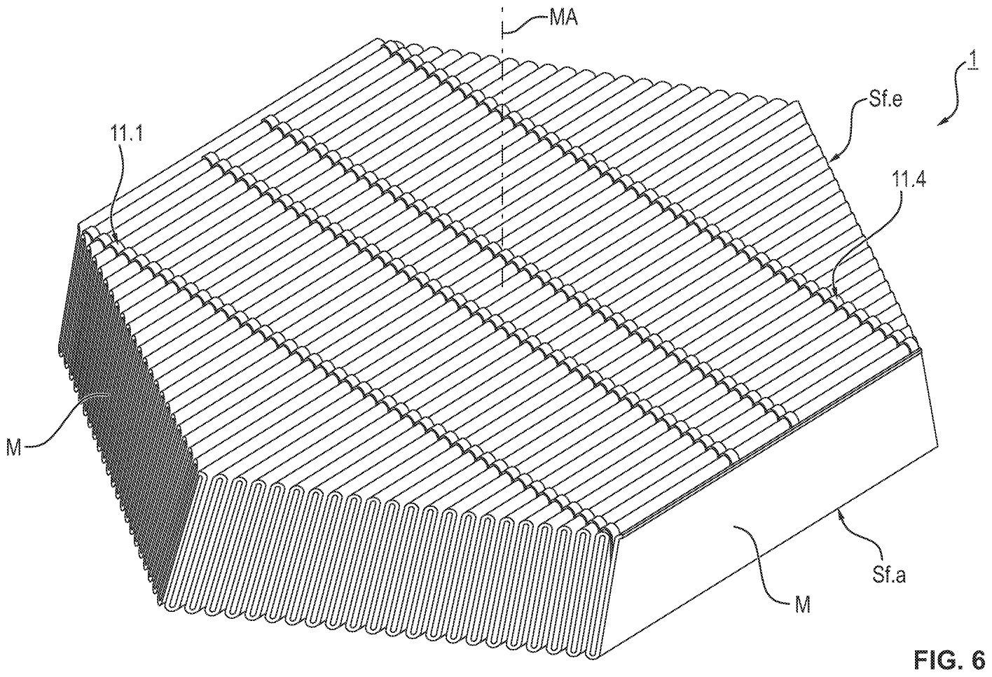

Because the particle filter 1 has a smaller end face Sf.a, Sf.e and a larger end face Sf.e, Sf.a, the lateral surface M is not perpendicular to the two end faces Sf.e and Sf.a. Rather, an obtuse angle α is formed between the smaller end face Sf.a, Sf.e and the lateral surface M, and an acute angle β is formed between the lateral surface M and the larger end face Sf.e, Sf.a, cf. FIG. 5. The obtuse angle α is preferably between 100 degrees and 115 degrees, particularly preferably between 105 degrees and 108 degrees. The acute angle β is preferably between 65 degrees and 80 degrees, particularly preferably between 72 degrees and 75 degrees. It is also possible that at least one end face Sf.a, Sf.e is arranged eccentrically relative to the center axis MA and therefore an angle occurs between this end face Sf.a, Sf.e and the lateral surface M which angle varies along the circumference of the end face Sf.a, Sf.e.

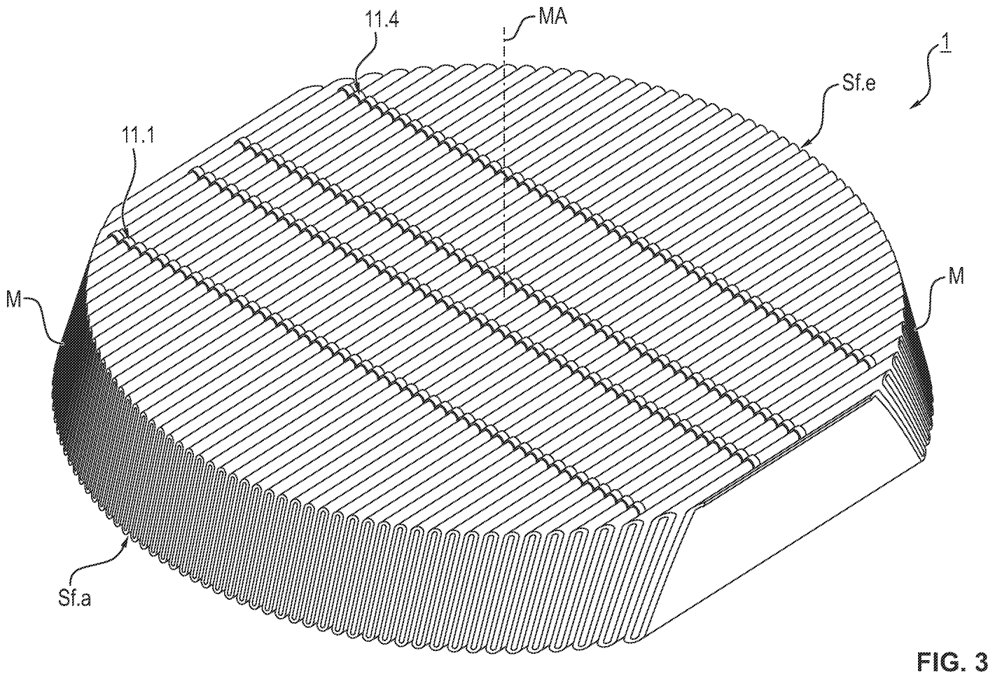

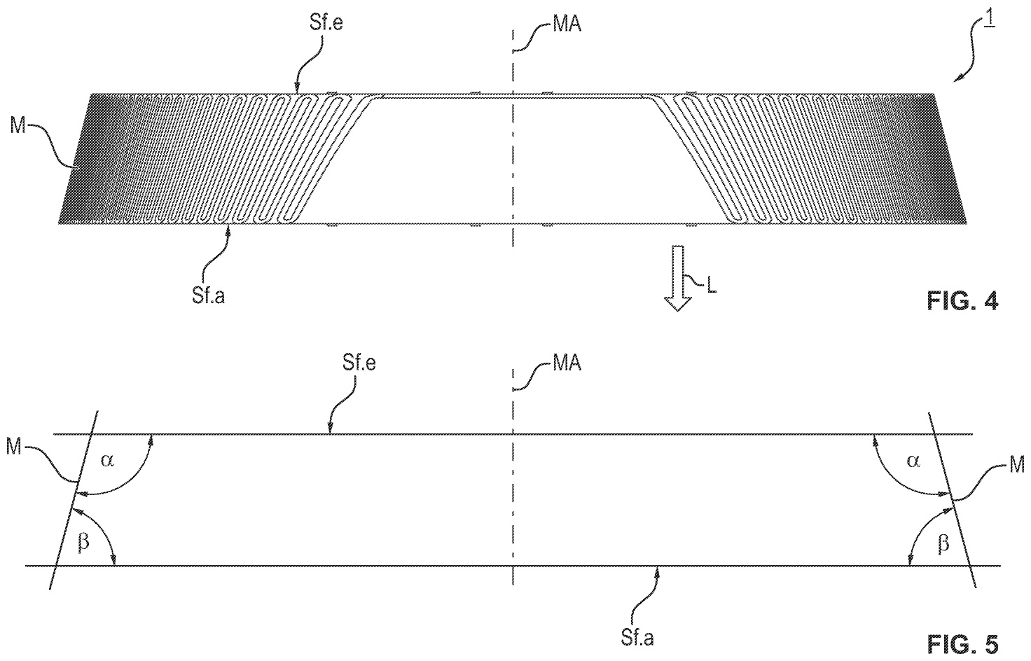

FIG. 3 shows a perspective view of a particle filter 1 according to the invention, which has the shape of a truncated cone. In FIG. 3, the smaller inflow-side end face Sf.e faces the observer, while the larger outflow-side end face Sf.a is concealed. FIG. 4 and FIG. 5 show a cross-section through the particle filter 1 of FIG. 3, with the center axis MA lying in the drawing plane of FIG. 4 and FIG. 5.

FIG. 5 shows the obtuse angle α between the smaller face Sf.e and the lateral surface M, and the acute angle β between the larger face Sf.a and the lateral surface M.

FIG. 3 shows that four parallel optional glue traces (glue lines) 11.1 to 11.4 are applied to the inflow-side end face Sf.e. These glue traces 11.1 to 11.4 hold the folded or pleated particle filter 1 together, and also during manufacture before the particle filter 1 is inserted into the housing. Of course, another number of glue traces is also possible. It is also possible that the glue traces extend over the outflow-side end face Sf.a. At least one trace of glue extends along the entire extent of the end face Sf.e, Sf.a.

FIG. 6 shows, from the same viewing direction as FIG. 3, a particle filter 1 which has the shape of a truncated pyramid. Each cross-sectional area perpendicular to the central axis MA has the shape of a regular hexagon. It is possible in general that the truncated pyramid has the shape of an n-gon with n>=3. Preferably, this n-gon is regular, but it can also be irregular.

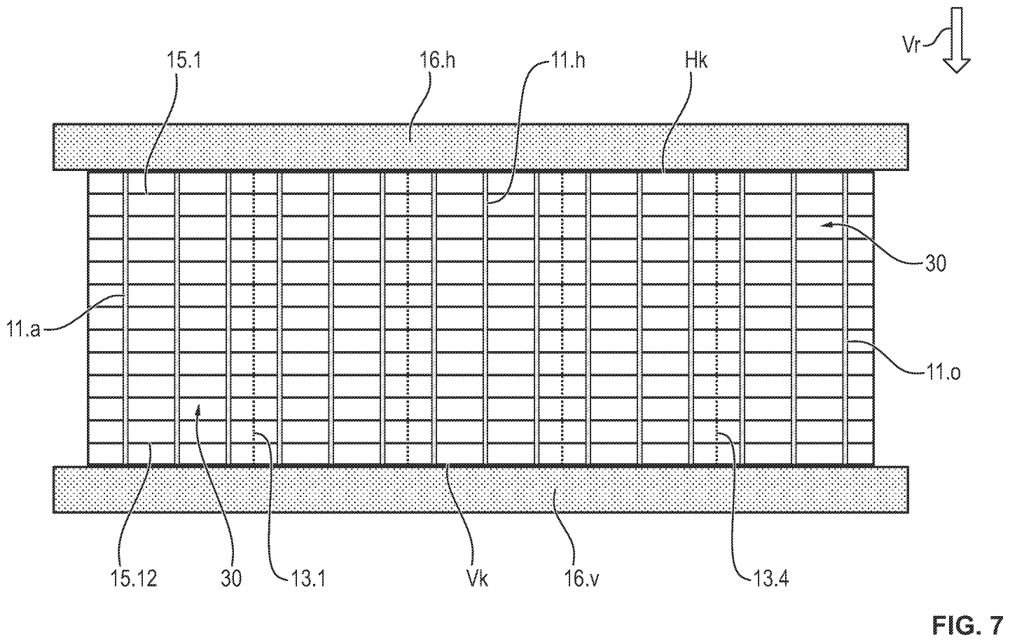

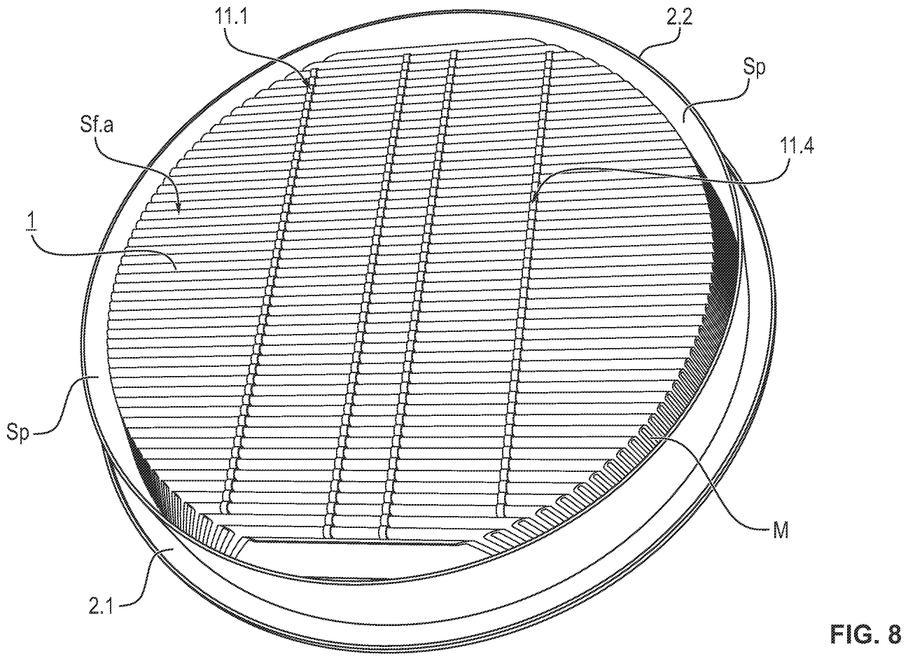

In the following, with reference to FIG. 7 to FIG. 12, a preferred process for manufacturing the filter unit 100 of FIG. 1 is described by way of example. A filter unit 101 of FIG. 2 can be manufactured in a corresponding manner.

FIG. 7 illustrates how a flat filter web 30 is pushed together to produce a corrugated or pleated filter web. A trailing edge Hk of the filter web 30 is moved in a feed direction Vr towards the leading edge Vk, thereby a corrugated shape is formed. It is possible that a sequence of kink edges (bend edges) 15.1, 15.2, . . . is introduced, for example punched, into the filter web 30, wherein the kink edges 15.1, 15.2, . . . are perpendicular to the feed direction Vr.

In the implementation shown, several parallel perforation tracks 13.1 to 13.4 were previously made in the filter web 30, for example punched in, in order to later divide (split) the filter web 30. In this way, cuboid-shaped particle filters can be produced. In order to produce several particle filters 1, each of which has the shape of a truncated cone, oval perforation tracks are preferably introduced into the filter web 30. It is also possible to first produce particle filters from the filter web 30, in which in each case the outer surface is perpendicular to the two end faces, and then to produce the shape of a truncated cone or truncated pyramid by cutting it out, preferably with the aid of a water jet cutter. This water jet cutter preferably has at least five axes of motion.

FIG. 8 illustrates a second intermediate result during manufacturing of the filter unit 100. The provided particle filter 1 has the shape shown in FIG. 3. The opened end face of the lid 2 faces the viewer. The particle filter 1, which has the shape of a truncated cone, has been inserted from above into the lid 2. The smaller outflow-side end face Sf.a with the optional glue traces 11.1 to 11.4 faces the viewer. The larger inflow-side end face Sf.e rests against the end face 2.1 of the lid 2. An annular gap Sp is formed between the tube 2.2 of the lid 2 and the lateral surface M, which tapers towards the end face 2.1 and away from the observer.

To produce a filter unit 101 as shown in FIG. 2, the particle filter 1 is accordingly inserted into the pot 4 from above. The smaller inflow-side end face Sf.e faces the observer. The larger outflow-side end face Sf.a rests against the bottom 4.1 of the pot 4.

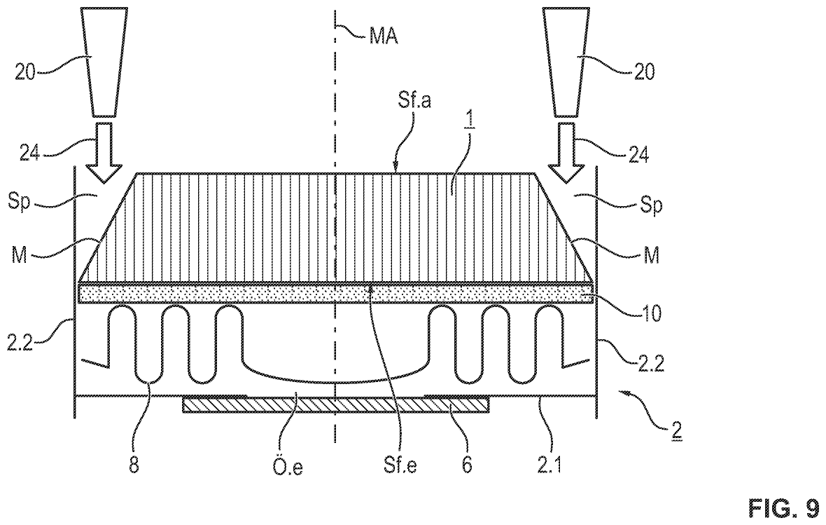

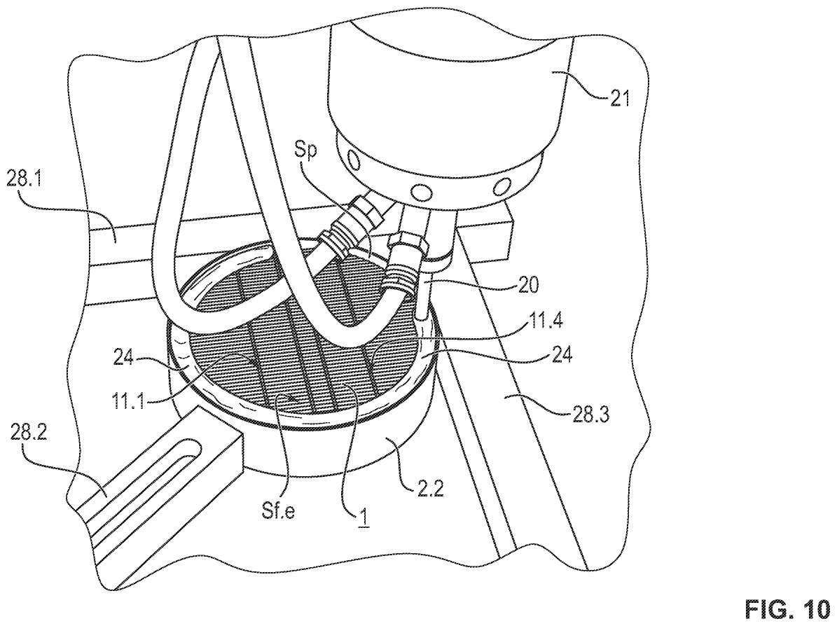

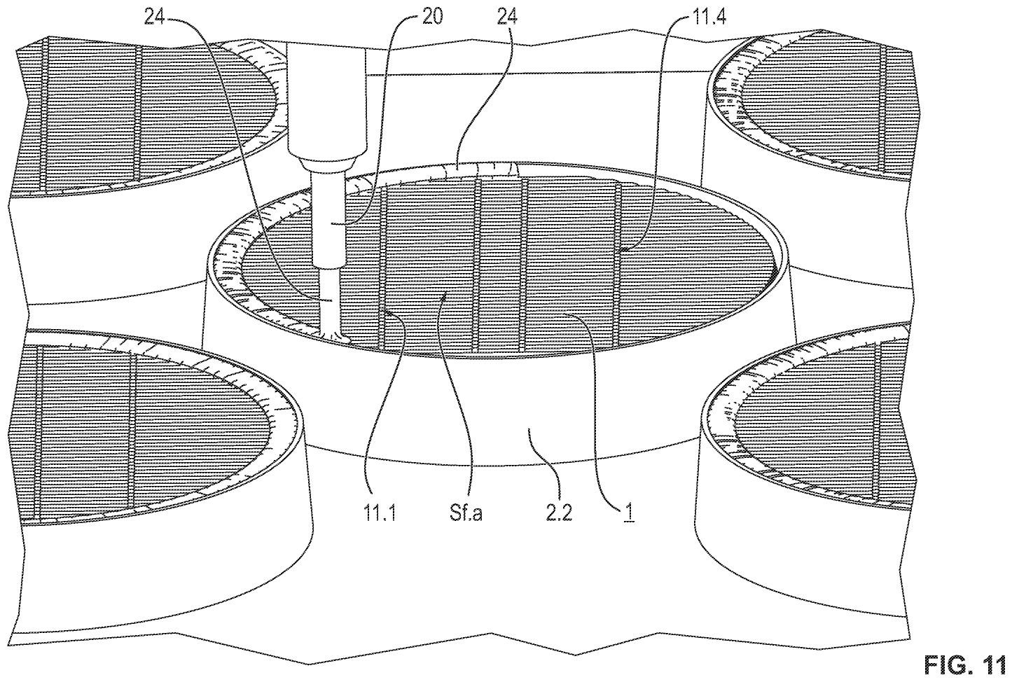

FIG. 9, FIG. 10, and FIG. 11 illustrate a subsequent step of the manufacturing process. FIG. 9 illustrates this step schematically in a cross-sectional view, with the center axis MA of the particle filter 1 lying in the drawing plane, FIG. 10, and FIG. 11 each in a perspective view. In FIG. 10, a container 21, in particular a tank, with liquid or viscous sealing compound 24 and a nozzle 20 are shown. In one embodiment, the sealing compound 24 in the container 21 is generated from at least two different components. It is of course possible to use more than one nozzle, cf. FIG. 9. The sealing compound 24 is, for example, a potting compound, a foam, or a hot glue. The nozzle or each nozzle 20 is positioned above the gap Sp.

The or each nozzle 20 is moved relative to the lid 2 with the particle filter 1 inserted, so that the or at least one, preferably each nozzle 20 is moved at least once along the entire gap Sp, i.e., along a closed path of movement. It is also possible that several nozzles 20 are used and that each nozzle 20 fills only a part of the gap Sp with sealing compound.

In the embodiment shown in FIG. 10, the lid 2 is held by a plurality of holding elements 28.1, 28.2, 28.3, and the or each nozzle 20 is moved at least once along a circular path above and along the gap Sp. The relative movement causes liquid sealing compound 24 to be dispensed from the container 21 through the nozzle 20 and into the gap Sp. It is also possible for several filter units 100, 101 to be produced in one work step, as exemplified in FIG. 11. This often means that fewer holding elements are required.

Thanks to gravity and optionally thanks to a possible overpressure in the container 21, the sealing compound 24 flows or runs downwards into the gap Sp. Generally, an area of the particle filter 1 adjacent to the gap Sp and to the lateral surface M absorbs or binds a portion of the introduced sealing compound 24. In addition, sealing compound 24 flows into the pleats of the particle filter 1. In a preferred embodiment, the sealing compound 24 cures (hardens) in the gap Sp and forms after curing the sealing element 9, thereby forming a material bond between the cured sealing compound 24, i.e., the resulting sealing element 9, and the particle filter 1.

Thanks to the sealing compound 24, which hardens to form the sealing element 9, it is not necessary to position the particle filter 1 exactly in the center of the lid 2. The sealing compound 24 compensates for any lateral offset between the particle filter 1 and the lid 2.

The corresponding step is carried out to produce a filter unit 101 according to FIG. 2. The sealing compound 24 is introduced into the gap Sp that occurs between the lateral surface M of the particle filter 1 and the tube 4.2 and hardens there.

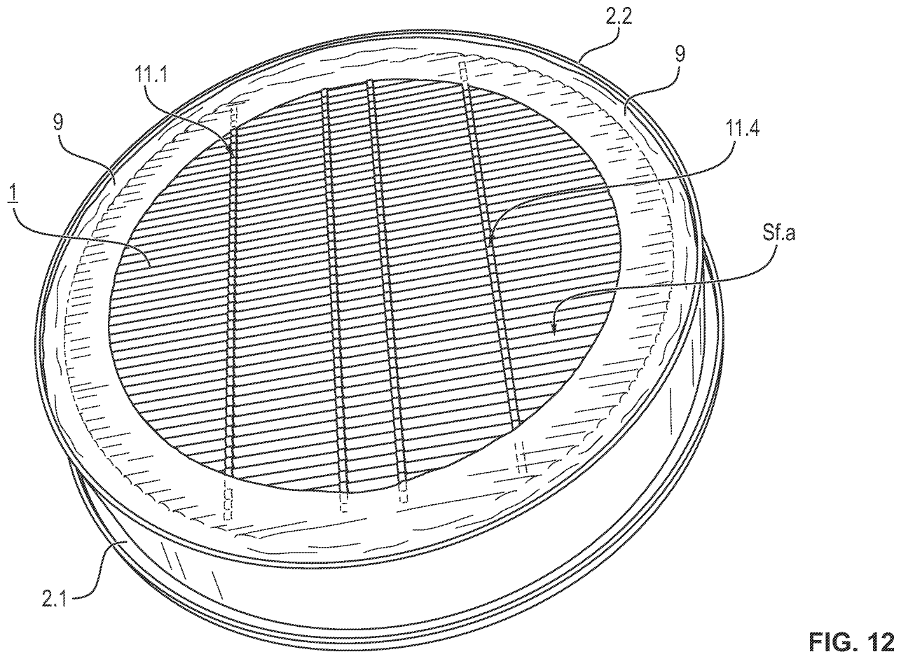

FIG. 12 shows a third intermediate result during manufacturing the filter unit 100. The gap Sp is filled with the sealing compound 24 and thereby sealed at the top. The sealing compound 24 fills the gap Sp completely or at least to such an extent that no relevant amount of particles flowing through the filter unit 100 can bypass the particle filter 1. Preferably, the sealing compound 24 also fills the gap Sp to such an extent that the particle filter 1 is securely held in the lid 2. The sealing compound 24 is at least partially cured and forms the sealing element 9.

In an alternative embodiment, the rigid filter block 40 is placed from above on the outflow-side end face Sf.a, followed by placing the optional damping layer 3, and then the pot 4 is slid (pushed) from above over the filter block 40, with the bottom 4.1 facing upward, and connected to the lid 2. In another embodiment, the optional damping layer 3 and the rigid filter block 40 are brought into the pot 4 from above, with the bottom 41 facing downward.

The step of inserting the particle filter 1 into the lid 2 and applying the sealant 24 to the gap can be timed to overlap with the step of inserting the rigid filter block 40 into the pot 4.

The lid 2 is then turned over so that the opening Ö.e on the inflow side in the lid 2 points upwards. The sealing element 9 holds the particle filter 1 in the lid 2. The lid 2 with the particle filter 1 is placed from above on the pot 4 with the rigid filter block 40. The lid 2 is connected to the tube 4.2.

Preferably, the lid 2 is put on before the sealing compound 24 has fully cured. The lid 2 thus helps to ensure that the sealing element 9 forms a reasonably flat end surface at the top.

While specific embodiments of the invention have been shown and described in detail to illustrate the application of the principles of the invention, it will be understood that the invention may be embodied otherwise without departing from such principles.

List of reference characters

| | |
|---|---|
| 1 | Particle filter in the form of a pleated package comprised |
| | of a planar filter web 30 folded in a wave shape, has the |
| | shape of a truncated cone or a truncated pyramid, has the |
| | inflow-side end face Sf.e, the outflow-side end face Sf.a |
| | and the lateral surface M, in one embodiment is |
| | rotationally symmetrical to the central axis MA |
| 2 | Lid (cover) of the housing of the filter unit 100, 101, has |
| | the inlet side opening Ö.e, includes the front side 2.1 and |
| | the tube 2.2 |
| 2.1 | Front surface of the 2, the inlet side opening Ö.e has |
| 2.2 | Tube of lid 2, overlapped with tube 4.2 of pot 4 |
| 3 | Optional damping layer on the outflow side, arranged |
| | between the rigid filter block 40 and the base 4.1 |
| 4 | Pot, belongs to the housing of the filter unit 100, 101, |
| | includes the bottom 4.1 and the tube 4.2 |
| 4.1 | Bottom of the pot 4, receives the coupling unit 5, has the |
| | outflow side opening Ö.a |
| 4.2 | Tube of the pot 4, in the embodiment example surrounds |
| | the tube 2.2 of the lid 2 |
| 5 | Coupling unit for detachably connecting the filter unit |
| | 100, 101 to a support comprises an external thread, |
| | arranged downstream of the outflow side opening Ö.a |
| | in the bottom 4.1 |
| 6 | Optional handle protection in front of the inlet |
| | opening Ö.e |
| 7 | Optional flame protection on the tube 4.2 |
| 8 | Optional further particle filter between the inlet opening |
| | Ö.e and the particle filter 1 |
| 9 | Sealing element in the form of a circular ring, seals the |
| | gap, created by curing from the sealing compound 24 |
| 10 | Optional inlet-side damping layer, is located between |
| | the particle filter 1 and the rigid filter block 40 |
| 11.1, . . . , 11.4 | Glue traces on the particle filter 1 |
| 11.a, . . . , 11.o | Glue traces on the filter web 30 |
| 13.1, 13.2, . . . | Perforation marks in the filter web 30 |
| 15.1, 15.2 | Buckling edges of the filter web 30 |
| 16.h | Moving rear stop edge for folding the filter web 30 |
| 16.v | Stationary front stop edge for folding the filter web 30 |
| 20 | Nozzle of a sealing device which creates the sealing |
| | element 9 in the gap from the liquid sealing compound |
| | 24 in the container 21 |
| 21 | Container with liquid sealing compound 24 |
| 24 | Liquid sealing compound, is introduced into the gap from |
| | above with the aid of the nozzle 20 |
| 28.1, 28.2, . . . | Optional holding elements, which hold the pot 4 with the |
| | particle filter 1 while the sealing compound 24 is filled |
| | into the gap Sp |
| 30 | Flat (planar) filter web, which is folded so that the |
| | particle filter 1 is formed |
| 40 | Optional rigid filter block, located downstream of |
| | particle filter 1 |
| 100 | Filter unit, which is capable of filtering out particles |
| | and gaseous components from a gas mixture, comprises |
| | the particle filter 1, the rigid filter block 40, the pot 4, |
| | the lid 2, the coupling unit 5, the sealing element 9, the |
| | optional damping layers 3 and 10, the optional particle |
| | filter 8 and the optional handle protection 6 |
| 101 | Filter unit, which is capable of filtering out particles |
| | from a gas mixture, comprises the particle filter 1, the |
| | pot 4, the lid 2, the coupling unit 5, the sealing element |
| | 9 and the optional damping layer 3 |
| Hk | Trailing edge of the moving filter web 30 |
| L | Flow direction in which a gas mixture flows through |
| | the filter unit 100, 101 |
| M | Particle filter lateral surface 1 |
| MA | Center axis of the particle filter 1 and the filter unit |
| | 100, 101 |
| Ö.a | Outflow-side opening in the pot 4, recessed in the |
| | bottom 4.1, arranged upstream of the coupling unit 5 |
| Ö.e | Opening on the inflow side in the lid 2, recessed in the |
| | end face 2.1 |
| Sf.a | Outflow-side end face of the particle filter 1, is perpen- |
| | dicular to the center axis MA, in one embodiment adjoins |
| | the filter block 40 |
| Sf.e | Inflow-side face of the particle filter 40 on the inflow |
| | side, is perpendicular to the center axis MA, is adjacent |
| | to the damping layer 10 in one embodiment |
| Sp | Annular (circumferential) gap between the lateral surface |
| | M and the tube 2.2 or 4.2, is at least partially filled by |
| | the sealing element 9, tapers in or against the flow |
| | direction L |
| Vk | Leading edge of the moving filter web 30 |
| Vr | Feed direction in which the filter web 30 is moved |

What is claimed is:

1. A filter unit to be arranged for a gas mixture to flow in a flow direction from an inflow side through the filter unit to an outflow side, the filter unit comprising:
a housing;
a particle filter arranged inside the housing, the particle filter comprising an inflow-side end face, an outflow-side end face and a lateral surface between the inflow-side end face and the outflow-side end face, the particle filter being configured to filter out particles from a gas mixture flowing in the flow direction through the filter unit, wherein one of the inflow-side end face and the outflow-side end face is a smaller end face and the other one of the inflow-side end face and the outflow-side end face is a larger end face, wherein a projection of the smaller end face along the flow direction onto the larger end face is such that the projection of the smaller end face is located entirely inside the larger end face, wherein the smaller end face and the larger end face are each perpendicular or oblique to the flow direction and wherein a circumferential gap is formed between the lateral surface and the housing, which circumferential gap is a tapering gap that tapers in a direction from the smaller end surface to the larger end surface; and
a sealing element at least partially arranged in the tapering gap.

2. A filter unit according to claim 1, wherein the particle filter has a corrugated or pleated shape.

3. A filter unit according to claim 1, wherein
the particle filter has the shape of a truncated cone with two circular or elliptical faces; or
the particle filter has the shape of a truncated pyramid with two faces each in the shape of an irregular n-gon or a regular n-gon.

4. A filter unit according to claim 1, further comprising a further filter element wherein:
the further filter element is arranged in the housing and downstream of the particle filter with respect to the flow direction; and
the larger end face of the particle filter is the inflow-side end face.

5. A filter unit according to claim 1, wherein the larger end face of the particle filter is the outflow-side end face.

6. A filter unit according to claim 1, wherein at least one of:
the smaller front surface is at an obtuse angle to the lateral surface and the obtuse angle is between 100 degrees and 115 degrees; and
the larger front surface is at an acute angle to the lateral surface and the acute angle is between 65 degrees and 80 degrees.

7. A filter unit according to claim 1, wherein the sealing element is materially bonded to a circumferential region of the particle filter adjacent to the outer surface.

8. A respiratory protection mask comprising a filter unit, the filter unit to be arranged for a gas mixture to flow in a flow direction from an inflow side through the filter unit to an outflow side, the filter unit comprising:
a housing;
a particle filter arranged inside the housing, the particle filter comprising an inflow-side end face, an outflow-side end face and a lateral surface between the inflow-side end face and the outflow-side end face, the particle filter being configured to filter out particles from a gas mixture flowing in the flow direction through the filter unit, wherein one of the inflow-side end face and the outflow-side end face is a smaller end face and the other one of the inflow-side end face and the outflow-side end face is a larger end face, wherein a projection of the smaller end face along the flow direction onto the larger end face is such that the projection of the smaller end face is located entirely inside the larger end face with the two end faces each perpendicular or oblique to the flow direction, wherein a circumferential gap is formed between the lateral surface and the housing, which circumferential gap is a tapering gap that tapers in a direction from the smaller end surface to the larger end surface; and
a sealing element at least partially arranged in the tapering gap.

9. A process for manufacturing a filter unit, the process comprising the steps of:
providing a first pot-shaped housing part and a second pot-shaped housing part, each housing part having an opened end face and an at least partially closed end face;
providing a particle filter, the particle filter comprising a smaller end face, a larger end face, and a lateral surface between the smaller end face and the larger end face, the two end faces each being perpendicular or oblique to a central axis of the particle filter, wherein a projection of the smaller end face along the central axis onto the larger end face is such that the projection of the smaller end face is located entirely within the larger end face, wherein the provided particle filter is configured to filter out particles from a gas mixture flowing parallel to the central axis through the particle filter;
inserting the particle filter into the first pot-shaped housing part such that the larger end face faces the closed end face of the first pot-shaped housing part;
after inserting the particle filter, a circumferential gap between the lateral surface and the first pot-shaped housing part is formed which gap tapers towards the closed end face;
introducing from the opened end face of the first pot-shaped housing part a liquid sealing compound into the gap such that the liquid sealing compound flows into the gap or is conveyed into the gap;
effecting or enabling that the sealing compound hardens or becomes viscous and then forms a circumferential sealing element which closes the gap against the opened end face of the first pot-shaped housing part; and
connecting the second pot-shaped housing part to the first pot-shaped housing part such that two interconnected housing parts together form a housing which completely surrounds the particle filter.

10. A process of claim 9, wherein:
before inserting the particle filter, the first pot-shaped housing part is positioned such that the opened end face points vertically or obliquely upwards;
the particle filter is inserted into the first pot-shaped housing part such that, after insertion, the smaller end face of the particle filter is located vertically or obliquely above the larger end face;
the liquid sealing compound is applied vertically or obliquely from above into or onto the gap; and
after insertion of the particle filter, the second pot-shaped housing part is placed on the first pot-shaped housing part from above and connected to the first pot-shaped housing part.

11. A process of claim 9, wherein a further filter element is provided, wherein the further filter element is inserted through the opened end face into the second pot-shaped housing part and after the steps of placing the particle filter in the first pot-shaped housing part and the further filter element in the second housing part,
the first pot-shaped housing part and the second pot-shaped housing part are connected together, and the housing formed by the two interconnected housing parts completely encloses both the particle filter and the further filter element.
